(19) United States
(12) Patent Application Publication
(10) Pub. No.: US 2003/0233274 A1
(43) Pub. Date: Dec. 18, 2003

(54) Methods and apparatus for gauging group choices

(76) Inventors: Arnold B. Urken, Hoboken, NJ (US); Dana Fagerstrom, Flamington, NJ (US)

Correspondence Address: GOODWIN PROCTER L.L.P, 7 BECKER FARM RD, ROSELAND, NJ, 07068, US

(21) Appl. No.: 10/283,927

(22) Filed: Oct. 30, 2002

Related U.S. Application Data
(63) Continuation of application No. 09/328,855, filed on Jun. 9, 1999, now abandoned.
Application No. 09/328,855 is a continuation of application No. 08/156,281, filed on Nov. 22, 1993, now abandoned.

(51) Int. Cl. G06F 17/60

(52) U.S. Cl. 705/12

(57) ABSTRACT

Methods and apparatus for a choice processor that gauges group choice in a computer-mediated environment. The system uses scientific analysis of collective choice processes and outcomes produced by different voting methods to provide result data to guide an individual or group in making decisions synchronously or asynchronously. Three forms of instantaneous result data are provided. First, the system makes use of distinctive user dialogue boxes to communicate a scientific description of the initial conditions of the group choice being initiated by an individual or group. This information is processed to select the voting system or systems that facilitate the achievement of organizational or individual objectives. Second, the system employs a series of novel data processing methods to determine collective choice results throughout a collective choice process to identify differences and to communicate to initiator(s) and participants result data generated by the system to guide them in achieving predetermined one or more predetermined objectives. And third, novel rule-based artificial intelligence techniques are employed to provide quantitative and verbal analyses to user about how to weight votes and how to interpret a consensus that is not based on complete information about voter preferences or judgments.

### CROSS-REFERENCE TO RELATED APPLICATIONS

This application is a continuation of Ser. No. 09/328,855, filed on Jun. 9, 1999, which is a continuation of Ser. No. 08/156,281, filed on Nov. 22, 1993. Both of the foregoing applications are incorporated herein by reference.

### FIELD OF THE INVENTION

The present invention is directed to processing group choices in a computer-mediated environment.

### DISCUSSION OF THE PRIOR ART

Recently, computer programs have been developed to allow computer users to vote from their personal computers attached to a computer network. The price of such decision support software has dropped drastically, but existing programs simply use the computer as a super-adding machine to determine the outcome for a particular voting system.

Until now, voting software has been designed to be used in “decision rooms,” where personal computers or terminals are connected in either a small, separate computer system or in a network and users are guided by a facilitator in reaching a group decision. Voters have no way of seeing or hearing agenda choices (e.g. competing products, color schemes, or product designs) on their screens so that they can obtain information to make them more informed decision makers. When choices must be made about many agenda items, voters have no way of indicating indifferent (or tied) preferences and cannot keep track of what their preference orderings look like so that they can make sure that the information that they input conforms that they input conforms to predetermined individual objectives and is consistent with predetermined priorities.

Even though some vendors of decision room software have expanded the types of network communications protocols that are used in networked computers, their products are still limited to the functionality found in decision room software.

In such environments, voting is treated as a mechanical process where the only guidance in choosing a voting system is provided by a facilitator, who, however well-trained, cannot keep up with the rapid interaction of comments and votes quickly enough to provide timely (“real time”) guidance to individuals.

A major limitation of such environments is that no provision is made and no mechanisms provided for the institutionalization of the history of deliberation and the voting data. Once the decision room sessions are finished, the data are not made available within the voting body (e.g. agency, company, department) to allow voters and management to continue the voting dialogue, taking account of new data and new questions to be voted on. Even if printed or electronic transcripts of decision room sessions are distributed, the continuity of the dialogue is lost because there is no way of resuming group deliberations online in local or wide area networks, multivendor hardware and software environments.

Another type of group decision or voting software enables a user who has collected data about voter preference orderings or judgments to make use of voting algorithms to process the data. This decision support software is designed for decision or management specialists, not for the average user's desktop. This type of software does not provide a mechanism to support the interactive and iterative voting dialogue required by users to achieve a resolution of issues and to obtain their objectives. Such a mechanism requires a capability to choose a voting method (i.e. setting up a framework for making a decision or viewing the collection of voting information at a particular point in the voting process) and to orient the dialogue in the direction most likely to achieve resolution of the decision process and, hence, the objectives of the voting dialogue.

Voting or polling by phone is another existing type of voting software. This type of product employs keyed-in responses to polls or questionnaires to ascertain group preferences and judgments. Voting is limited to binary choices and opportunities for extracting insight are not exploited because voting is treated a theoretically as if it involved nothing more than counting single votes. Moreover, this form of voting does not make use of voice interfaces to communicate voting information (e.g. intensity of preference) that can provide insight when participants in a conference telephone call are trying to reach consensus, but hampered by information overload and distortion.

Computer-mediated group decision making software is not only produced for human decision makers, but is also designed for computer nodes and processes that act as if they were human agents. This type of software creates protocols to solve problems in the management of computer networks such as reaching a consensus to ensure consistency and providing communications reliability in network environments. Typically, however, the solutions to these problems are limited because the voting systems employed do not take account of insights that can be derived from scientific voting analysis. This limitation leads designers to conclude that certain problems are insurmountable when they are not. The same myopia prevents the development of selfadjusting networks in which computer agents use voting systems that can be used to resolve and regulate conflicts that must be managed to provide network stability and efficiency.

Prior art is disclosed in U.S. Pat. Nos. 5,878,214, 5,875,432 and 5,759,101.

U.S. Pat. No. 5,878,214 discloses a computer based method of problem solving of a group involves establishing an agenda and a list of ideas for solving the problem. The patent also discloses that the method would include listing actions and assigning accountability. Essentially, this patent describes brainstorming being carried out among a large group using computer technology.

U.S. Pat. No. 5,875,432 discloses a computerized voting information system designed to deal with voting in elections and authenticating the identity of the voters. The problems dealt with by this patent are efficient security systems. The only voting system dealt with in the patent is majority voting.

U.S. Pat. No. 5,759,101 discloses a system method for expanding the audience to television programs to external audience beyond those located in the studio. The patent also discloses technology for collecting their responses and awarding scores.

### SUMMARY OF THE INVENTION

The present invention is directed to methods and apparatus for interpreting and communicating computer-mediated voting. A choice processor mechanism enables users to gain sophisticated insights into a voting process derived from scientific analysis of voting inputs. The present invention includes synchronous and asynchronous modes of interaction, communication, and analysis of collective choice results.

The method and apparatus of the present and unique invention are based on five modules, a user interface module, a common data interchange module, a decision setup module, a data collection module, and a decision review/analysis module. The User Interface Module determines the media for input and output of data in the present invention.

The common data interchange module handles all of the input and output of the system including the data transactions between and among the modular parts of the system. The common data interchange module provides a structure for communicating multipurpose information including animation, video (real-time or stored), graphics, sound, hologram, or any other representation of information. This common data interchange module provides the channel in which a user inputs information and receive responses. The user can be a human being, a process or node acting as if it were a human being, or a physical object programmed to act like a human being. Commands and responses can include one or more forms of multi-purpose information.

The decision setup module provides a facility for creating an agenda and a list of agenda items to be voted on. The agenda can be created by brainstorming to create a list and then evaluate it to identify items that should constitute the agenda. Or the agenda can be created by selecting a preexisting template or model agenda for a task. Agendas created from scratch can be saved as templates and agendas set up from a template can be either edited or modified to fit a situation.

The decision setup module allows users to attach multi-purpose files as background information. These files, which can be copied or simply referenced (by their network address), can be either previewed, edited, or deleted within this module. This module also allows an initiator of a decision to determine the decision participants, to set their privileges in accessing information about the decision process and outcome, to select a method of scoring or voting to be used by the participants, and to define the schedule and mode of interaction (synchronous or asynchronous) of the decision.

When the decision setup module is saved and closed, all participants automatically receive a multipurpose message (e.g. either voice-mail, fax, or electronic mail) notifying them about the decision agenda and schedule. The data collection module collects information about voter ratings as well as their comments from the common data interchange module based on the conditions created in the setup module and communicated via the common data interchange module. The data collection module also allows voters to share either public or private messages through a dialogue mediated by the common data interchange module, which automatically archives multipurpose information in hypertext-accessible databases.

The data collected are communicated via the common data interchange module to the review/analysis module, where they are analyzed according to a filter to guide users in interpreting information about the group decision making process. Representative embodiments of the present and unique invention allow users to gain insight into avoiding obstacles and making optimal choices in interpreting collective outcomes. The review/analysis module also provides insights by guiding users in setting up a decision in the setup module and in monitoring trends during the data collection phase of a group decision.

A preferred embodiment of the invention includes a number of selected terminals interconnected by a network; each of the selected terminals having an input device; a server on the network; a data base on the server; the data base having storage fields for receiving and providing data an input data object generator for generating a number of input data objects having input fields associated with related storage fields of the data base and for delivering one of the number of input data objects to each of the number of terminals so that each of the input devices can be used to input data into the input data object and the input data object can be sent to the data base for the data to be received thereby an output data object generator for generating an output data object having output fields associated with one or more of the related storage fields of the data base for the data base to provide data to output data object; and a choice generator for receiving and manipulating the data from the output data object to provide the result of the choice.

The preferred embodiment could also include a module for selecting the selected terminals out of all the terminals attached to the network. The identity of these selected terminals may be masked from the administrator of the system.

The results of the processing by the choice generator may be displayed on selected terminals.

The input device may be a keyboard or a pointing device.

The input data objects may be constructed from a library of such input data objects. The input data objects may contain logic to change the presentation of fields depending on the data being supplied.

The choice generator may use a variety of scoring rules, types of choices, and aggregation rules to calculate results. The choice generator can also assign different weights to different votes based on select criteria. The choice generator can break ties by using different scoring systems.

Another aspect of the invention is a method for making a collective choice including the steps of providing a number of selected terminals interconnected by a network; each of the number of terminals having an input device; providing a server on the network; providing a data base on the server; the data base having storage fields for receiving and providing data; providing an input data object generator for generating a number of input data objects having input fields associated with related storage fields of the data base and for delivering one of the number of input data objects to each of the number of terminals so that each of the input devices can be used to input data into the input data object and the input data object can be sent to the data base for the data to be received thereby; providing an output data object generator for generating an output data object having output fields associated with one or more of the related storage fields of the data base for the data base to provide data to output data object; and providing a choice generator for receiving and manipulating the data from the output data object to provide the result of the choice.

The method could also include a module for selecting the selected terminals out of all the terminals attached to the network. The identity of these selected terminals may be masked from the administrator of the system.

The results of the processing by the choice generator may be displayed on selected terminals.

The input device may be a keyboard or a pointing device.

The input data objects may be constructed from a library of such input data objects. The input data objects may contain logic to change the presentation of fields depending on the data being supplied.

The choice generator may use a variety of scoring rules, types of choices, and aggregation rules to calculate results. The choice generator can also assign different weights to different votes based on select criteria. The choice generator can break ties by using different scoring systems.

Another aspect of the invention is a machine readable medium which when combined with a computer system provides a number of selected terminals interconnected by a network; each of the number of terminals having an input device; a server on the network; a data base on the server; the data base having storage fields for receiving and providing data; an input data object generator for generating a number of input data objects having input fields associated with related storage fields of the data base and for delivering one of the number of input data objects to each of the number of terminals so that each of the input devices can be used to input data into the input data object and the input data object can be sent to the data base for the data to be received thereby; an output data object generator for generating an output data object having output fields associated with one or more of the related storage fields of the data base for the data base to provide data to output data object; and a choice generator for receiving and manipulating the data from the output data object to provide the result of the choice.

The machine readable medium could also include a module for selecting the selected terminals out of all the terminals attached to the network. The identity of these selected terminals may be masked from the administrator of the system.

The results of the processing by the choice generator may be displayed on selected terminals.

The input device may be a keyboard or a pointing device.

The input data objects may be constructed from a library of such input data objects. The input data objects may contain logic to change the presentation of fields depending on the data being supplied.

The choice generator may use a variety of scoring rules, types of choices, and aggregation rules to calculate results. The choice generator can also assign different weights to different votes based on select criteria. The choice generator can break ties by using different scoring systems.

### BRIEF DESCRIPTION OF THE DRAWINGS

FIG. 1 schematically illustrates elements of an environment for group decision making according to the present invention.

FIG. 2 is a schematic functional diagram of a setup module utilized in the present invention makes use of the elements represented in FIG. 1.

FIG. 3 schematically shows the functionality associated with a data collection module according to controls input in FIG. 2 of the present invention.

FIG. 4 schematically illustrates a review module for analyzing data input from FIG. 3.

FIG. 5 schematically illustrates the process of integrating multimedia information in the Common Data Exchange of the present invention.

FIG. 6 is a schematic representation of an Agenda setup window integrating the features of the present invention.

FIG. 7 is a schematic illustration a Voting window that integrates features of the present invention.

FIG. 8 is a schematic representation of a Review window that integrates features of the present invention.

FIG. 9 is a schematic representation of steps used in the exemplary processor for analyzing voting information in FIGS. 2, 3, and 4.

FIG. 10 is a block drawing of the structure of the preferred embodiment of the invention.

### DETAILED DESCRIPTION OF THE INVENTION

A representative embodiment of the present invention can be implemented in X-Windows (a trademark of MIT), SPARC (a trademark of SPARC International) or Microsoft Windows (a trademark of Microsoft), OS/2 (a trademark of IBM), NT (New Technology, a trademark of Microsoft) or JAVA (a trademark of Sun Microsystems) operating system environments.

Structure of Preferred Embodiment

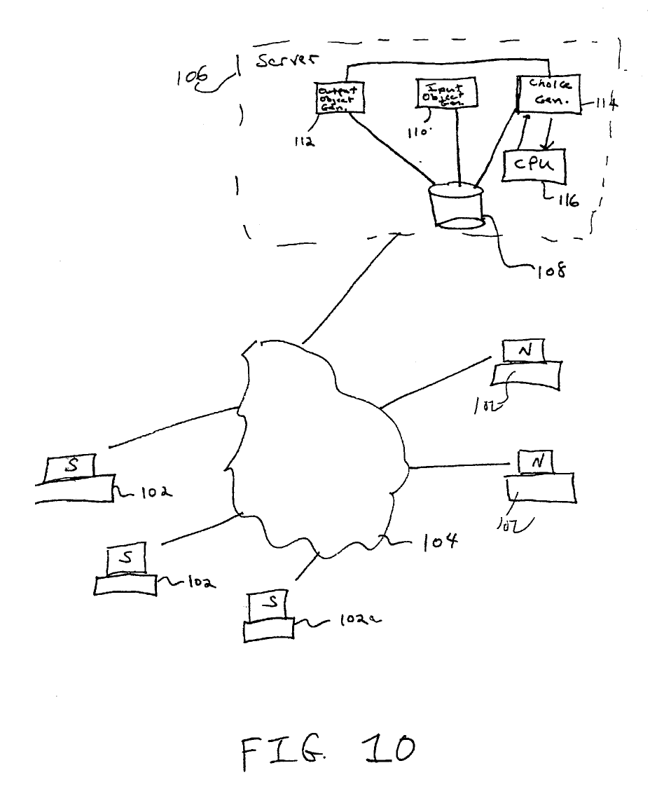

Referring now to FIG. 10, the structure of the preferred embodiment of the invention includes a number of computer terminals 102. Each of computer terminals 102 is connected to communication network 104. The communication network 104 can be any network such as a local area network, a phone or cable network or the Internet. Also connected to the communication network 104 is a computer server 106. The computer server 106 contains a number of physical and software objects. These objects include a database 108, an input object generator 110, an output object generator 112, and a choice generator 114. Each of the output object generator 112, the input generator 110 and the choice generator 114 can communicate with database 108. The choice generator 114, in addition, can communicate with the output object generator 112. The choice generator 114 can also communicate with the central processing unit 116 of the server 106.

The preferred embodiment also includes a module for selecting a number of computer terminals 102. The selection can be accomplished by the user of terminal 102a.

Preferred Embodiment in Operation

Referring again to FIG. 10, the operation of the preferred embodiment involves the creation of an input data object by the input object generator 110. In creating the input data object 110 the input data object generator receives commands from terminal 102a. The input data object generator 110 draws upon the database 108 to create the input data object. The input data object is one or a number of questions. Each set of questions is commonly known in the art as an agenda. Each question of an agenda consists of a question, choices and an answer format.

The agenda, which is an input data object, is transmitted over communication network 104 to a number of selected terminals 102. (Each of the selected terminals are identified with an “S” in FIG. 10.) There may be other terminals on the communication network that are not selected. (Each of the non-selected terminals is identified by a “N” in FIG. 10.) The input data object appears on the screens of the selected terminals 102. The users of the terminals then answer the questions posed by the agenda by filling in fields. The answers may change the order of the questions or the types of questions presented. These contingencies are programmed in the input data object. The completed input data objects are transmitted back to the server 106 over communication network 104 and are stored in database 108. From time to time, the output object generator 112 will access the database 108 and create an output data object that incorporates the stored answers to the agenda. Upon command, the output data object is manipulated by the choice generator 114. The manipulation can take the form of changing the scoring rule, the weighing rule or the aggregation rule associated with representation of the answer to the agenda question. After manipulation, the output data can be displayed.

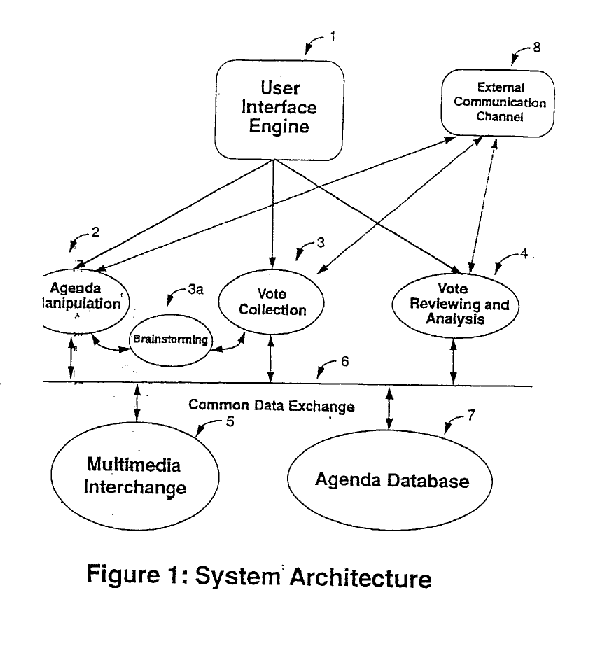

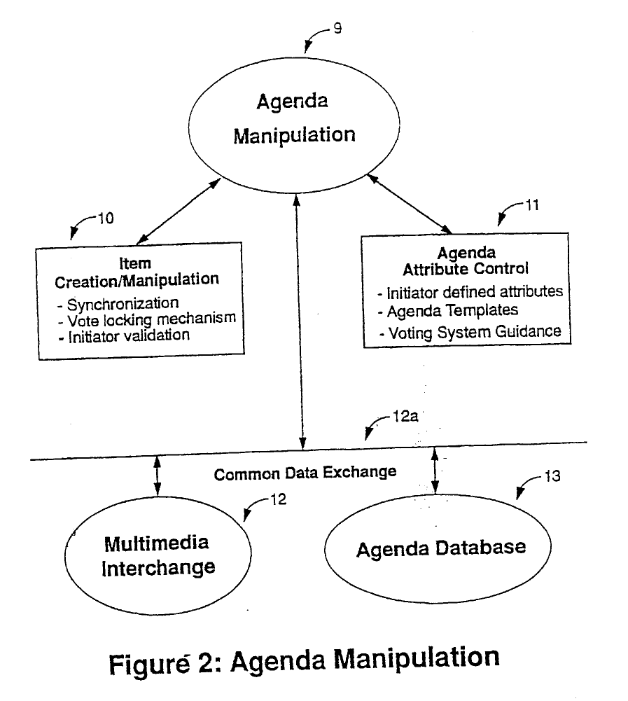

The present invention includes a user interface module (block 1 of FIG. 1), such as input object generator 110, a decision setup module (agenda manipulation shown in block 2 of FIG. 1), also in input data object generator 110, a data collection module such as database 108 (vote reviewing and analysis in block 4 of FIG. 1), and a common data exchange module (block 6 of FIG. 1), such as the choice generator 114 and CPU 116. These modules provide a structure in which synchronous and asynchronous communication and interpretation of voting, textual, image, graphical, sound, animation, video (stored or live), quantitative, textual, and other information is organized to enable computer users to initiate and participate in informed group decisions from their desktops.

Each module inputs, processes, and outputs all of these types and forms of data and information used in collective decision making. Processing of data and information between and among modules can take place sequentially or concurrently to guide group choices.

User Interface Module

A user interface module in block 1 of FIG. 1 determines the medium or media that are used for data input and output in the present invention. This module includes options for using multimedia, multipurpose information, mechanical, touch-screen, and optical devices such as mice, pens, and keyboards, voice and neurological data to enter data into the modules and receive output. The user interface module uses different media suitable to the task at hand and provides redundant communication when necessary.

Decision Setup Module and Voting System Guidance Submodule

A setup module (agenda manipulation in block 2 of FIG. 1) in the present invention provides a means for an individual initiator or a group of initiators to input data that create the initial conditions which govern a collective choice process. These conditions include identification of an agenda (including an agenda name, list of agenda items, agenda and agenda-item background descriptions, and multimedia, multipurpose information attached to the agenda and agenda items), timing of the decisions (when they begin and end and whether they are synchronous or asynchronous), determination of participants, voter identification, participant privileges, and voting or scoring system.

A feature of the decision setup module in the present invention shown in detail in FIG. 2 is a menu-driven system for setting up an agenda topic, adding agenda items, and attaching multimedia, multipurpose files to items. This feature is useful because it allows anyone to make use of a multimedia environment to pool information and avoid telephone tag, electronic mail chasing, and face-to-face meetings to carry out their work.

A related feature of agenda setting in the decision setup module of the present 20 invention is a hypertext system in block 13 of FIG. 2 for relating agendas and agenda items. This menu-driven system is useful for searching across active and inactive agendas for agenda items and related multimedia information. This hypertext system enables a group to have an electronic organizational memory by allowing identification of issues, opinions, data represented by multimedia files that can be used in current and future collective deliberations and decisions.

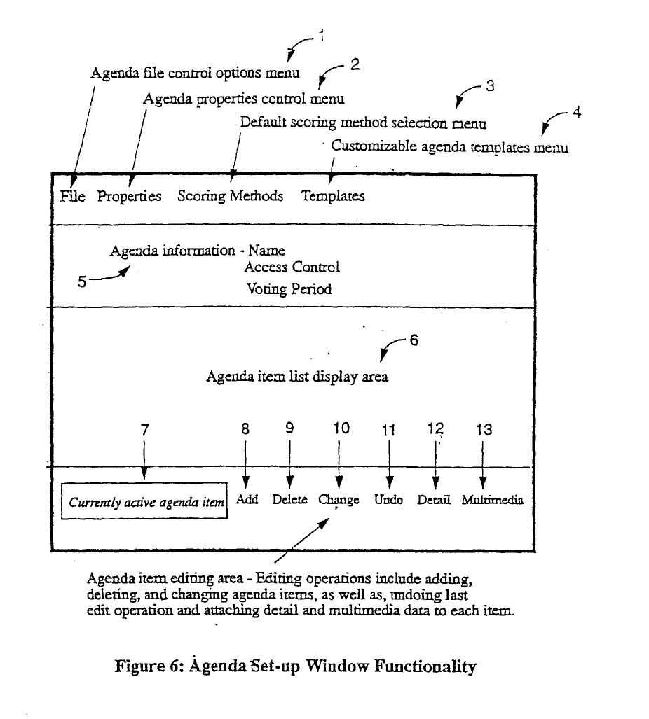

Another feature of the decision setup module in FIG. 2 of the present invention is a menu-driven system (shown in a representative embodiment in FIG. 6) for determining the timing of a collective decision. Users can employ all of the options in the user interface module in block T of FIG. 1 to enter data for synchronous and asynchronous decisions via the common data exchange module into the setup module.

Another feature of the decision setup module in the present invention in block 11 of FIG. 2 is a menu-driven system (shown in a representative embodiment in block 5 FIG. 6) for determining the participants in a collective choice process. Users can employ all of the options in the user interface module to enter participants, who can be selected individually from a list of all users on the network, from a list based on organizational affiliation, position, role, and any other criterion for categorization, or from predetermined lists of nominal groupings of users created for personal or organizational purpose. This menu also includes an option for allowing everyone on the network to participate.

Another feature of the setup module in block 11 of FIG. 2 in the present invention (shown in a representative embodiment in block 5 of FIG. 6) is a menu-driven voter identification option that enables an individual or group initiating a decision to allow voters to remain anonymous or permit them to be partially or fully identified. If anonymity is chosen the setup module invokes an omniscient initiator in the present invention, a computer process that knows the identities of voters, but does not make this information accessible to initiator(s) or participants. The omniscient initiator assures that ratings, votes, changed ratings and votes, and associated comments, and background information are controlled to provide privacy and reliable and consistent access to data. The omniscient initiator begins and ends its work in accordance with timing conditions in the setup module. If an agenda for a terminated collective decision is reopened, theomniscient initiator resumes operation for the new voting process based on stored information about voter identities.

These options for voter identification are important because they enable individual and collective choices to be analyzed for patterns that are used to guide groups in resolving conflicts. For instance, a collective outcome that includes a tie between twoagenda items, say A and B, two products designs, may be interpreted as aconsequence of intraorganizational departmental or division conflicts based on homogeneous votingpattems. The ability to identify background characteristics of the voters makes it possible to gain insight by determining if, say, engineers and designers are split along departmental or divisional lines or if some engineers and designers agree with each other. This type of insight affects the choice of a strategy for resolving the tie.

Another feature of the decision setup module in block 9 of FIG. 2 (shown in a representative embodiment in block 5 of FIG. 6) in the present invention is a menu-driven set of options for determining privileges of participants in a voting process. Such privileges are also known as “properties of a voting process” that govern individual participation. These privileges include options for being enabled to cast votes, for editing an agenda, for previewing and reviewing collective outcome data, and for receiving notifications. If an initiator or group of initiators enables voting, participants are allowed to rate and score alternatives in the data collection module.

Making participants vote-disabled and preventing them from editing an agenda enables an initiator to open up the review module to individuals and groups who did not participate in the collective choice process, but still want access to information about the collective outcome and the reasons behind the collective outcome.

A related feature of privilege setting in the decision setup module of the present invention is the option of previewing and reviewing collective choice results. The previewing privilege determines if a participant can gain access to the review module before or after all participants have cast their votes. Preventing access to collective choice data and analysis before all votes are collected and processed is useful in prohibiting participants from monitoring incoming votes to obtain information that can be used to bribe, pressure, or persuade voters. Restricting access to collective choice data even after all votes are in can be used in private polls in which data are considered to be confidential or sensitive.

Voting systems filter voter preference data that constitute a set of initial conditions that characterize voting processes. A logical analysis of voting system comparisons is illustrated by a simple voting scenario presented in Tables 1 and 2.

TABLE 1
Cardinal Preferences of Four Voters for Three Alternatives

| | 1. Voters' Cardinal Utility Ratings | | | | |
|---|---|---|---|---|---|
| Choices | Voter 1 | oter 2 | (a) | Voter 3 | Voter 4 |
| A | 5 | 3 | | 2 | 1 |
| B | 4 | 6 | | 3 | 4 |
| C | 1 | 1 | | 5 | 5 |

TABLE 2
Vote Allocations and Collective Outcomes Under One Person,
One Vote (OPOV) and Approval Voting (AV) Methods

| | 2. Voter Allocation by Method | | | | | | | |
|---|---|---|---|---|---|---|---|---|
| | 3. OPOV | | | | 4. AV | | | |
| Choices | 1 | 2 | 3 | 4 | 1 | 2 | 3 | 4 |
| | 1 | 0 | 0 | 0 | 1 | 1 | 0 | 0 |
| | 0 | 1 | 0 | 0 | 1 | 1 | 1 | 1 |
| | 0 | 0 | 1 | 1 | 0 | 0 | 1 | 1 |

| | |
|---|---|
| Plurality Outcome: C | Plurality Outcome: B |
| Majority Outcome: Indecision | Majority Outcome: Indecision |
| Collective Ordering: | Collective Ordering: |
| C > B <> A | B > A <> C |

Table 1 shows four voters (1-4) who have cardinal preferences for choices A through C. This means that each voter's ranking shows how much one choice is preferred to another. For instance, voter 1 prefers choice A five times as much as choice C and rates choice B four times as high as choice C. The choices may involve meeting times, product designs, restaurants, or any situation that requires a group to choose among two or more alternatives. But all of these choices depends on common logical features of voting procedures.

The filtering affect of voting systems on this cardinal preference information is illustrated in Table 2, which contrasts two voting rules. One rule is one person, one vote (OPOV) and the other is approval voting (AV). Under OPOV rules, voters are restricted to casting one vote for their most preferred choice. If than one choice is most preferred, this information will be lost in the process because the vote cannot be divided to represent this condition. In contrast, under AV, voters can cast one vote for each approved choice. Since approval voting involves a subjective judgment about what criterion to use is casting an approval vote, voters may have different thresholds for allocating approval votes, but in this exposition, it is assumed that voters act as if they vote for each alternative that equals or exceeds their average cardinal rating. In Table 2, this means that since all the cardinal ratings in Table 1 are normalized on a ten-point scale, any choice rated 3 or higher receives an approval vote. Table 2 describes the impact of aggregation rules on collective outcomes. When the objective is to select a single choice, plurality or majority rule can be used. Under OPOV, C gains the most votes, while under AV, B is the plurality outcome. When majority rule is employed, the outcome is indecisive under OPOV and AV. If the decision task is to produce a collective rank-ordering of the choices, OPOV and AV produce different interpretations of the voters' preference information. For OPOV, the group prefers C to B and A and is indifferent between A and B. In contrast, AV suggests that voters are indifferent between A and C and prefer B to A and C.

This illustration shows that voting systems are not neutral and that voters who choose a voting system may unwittingly produce a collective outcome that they could avoid if they were aware of the consequences of their decisions and options for choice. For instance, in this scenario, if A, B, and C are product designs, the group concludes that there is no consensus if it requires a design to receive a majority of votes. If a plurality of votes is required to define a group consensus, either voting method produces a decisive choice, though the outcomes are inconsistent (i.e. one system identifies C as the group choice and the other determines that B is the group choice).

A feature of the voting system guidance module in the decision setup module in the present and unique invention is the resolution of this type of inconsistency by filtering the initial conditions of a voting situation through many voting systems. In fact, voting analysis provides insights into how groups can achieve their goals by using decision analysis feedback to make use of interpretations of dynamic, complex voting processes that would normally elude voters.

A feature of the present invention in block 11 of FIG. 2 (shown in a representative embodiment in block 3 of FIG. 6) is a menu-driven system for selecting and using all known voting systems and extracting information from them that is used to guide voters in setting up and analyzing a group decision making process. This system menu-driven system makes use of all types of inputs from the user interface engine module in block 1 of FIG. 1 and transmits these inputs via the common data exchange module in block 12a in FIG. 2 to the setup module in block 2 of FIG. 1, which processes them and then outputs them to the data collection module (block 3 of FIG. 1) and review module (block 4 of FIG. 1), where they are used to control the processing of information about a voting process.

In addition to one-person, one vote and approval voting systems, this voting-system selection feature includes but is not limited to voting systems such as Borda voting, Condorcet scoring, Copeland scoring, proportional voting (e.g. Single Transferable Voting), and different forms of weighted voting (including systems such as the demand-revealing process (T. N. Tideman and G. Tullock, (1976), “A New and Superior Process for Making Social Choices,” Journal of Political Economy.) and fair division schemes (S. J. Brams and A. D. Taylor, (forthcoming) “An Envy-Free Cake Division Protocol, American Mathematical Monthly. In weighted voting, votes can be weighted according empirical measures of expertise, self-assessments of expertise, intensity of preference, or subjective estimates. (H. Nurmi (1987). Comparing Voting Systems. Dordrecht: D. Reidel Publishing Company; Shapley, L. and B. Grofman (1984). “Optimizing Group Judgmental Accuracy in the Presence of Interdependencies,” Public Choice.) Each of these systems is characterized by rules that govern representation of voter preference information by an allocation of votes and by rules that regulate aggregation or pooling of allocated votes. This aggregated information is then interpreted by listing agenda items according to the scores they received under a voting system. The same information is also useful for determining if one or more agenda items receives a certain required percentage of the total votes, e.g. majority. This requirement is also known a “decision rule” or “group decision rule.”

The rules of the voting system guidance of the decision setup module used to create these 30 insights are based on contingent relationships between the factors associated with use of a system (Arnold B. Urken, (1988). “Social Choice Theory and Distributed Decision Making.” in R. Allen (ed.) Proceedings of the IEEE/ACM Conference on Office Information Systems). For example, if an agenda includes three or more agenda items and the objective is to select a single item, the voting system guidance module in the present and unique invention does not recommend one person, one vote voting, but guides a user to select a system that provides more information about the structure of voters' preference orderings. Approval voting is suitable unless there is strong disagreement among the voters. If this seems likely, another system such as Borda voting can be used in order to avoid the possibility of creating a tie (which, under heterogeneous preferences, can be five times more probable under approval voting than it is under one person, one vote voting). Alternatively, the voting system selection menu can be set up via the user interface engine module n block 1 of FIG. 1 and common data exchange module in block 6 of FIG. 1 to collect preference rating data in the data collection module in block 3 of FIG. 1 and to notify the decision analysis module of the review module in block 3 of FIG. 1 to analyze the voting process by processing the preference information through each voting system.

This feature is useful because it presents users with options for breaking ties by extracting information that can be used to make non-obvious distinctions among tied agenda items.

A related feature of the voting system guidance module in block 11 of FIG. 2 is that it makes use of implicit information about voter preference structures derived from a voting system setup to enable analysis of a voting process to be done in the decision analysis module of the review module. This is true even if a particular voting system is selected directly through the voting system selection menu. For example, voting systems such as Borda voting contain information about individual preference orderings that can be used as inputs for other systems of voting to compare the collective outcomes with the results of Borda scoring. Moreover, even categorical voting systems such as approval voting contains implicit information about the relative ordering (also known as the “ordinal relationship”) of agenda items in voter preference structures that can be used in the decision analysis module of the review module to analyze collective outcomes to gain insight. For under approval voting, the “approved set” of agenda items (which receive 1 vote each instead of 0 votes each) are implicitly ranked higher than the “disapproved set.” This information may be useful in resolving a tied outcome under approval voting by making use of voting analyses of other systems in the decision analysis module of the review module.

These types of insights are useful because they enable a group to be more efficient in reaching a consensus. No extra time or effort is required to identify and resolve disagreements that can be avoided by choosing a voting system.

A related feature of this voting system guidance module in the decision setup module in block 11 of FIG. 2 of the present invention is an option that allows an initiator to input a setting that permits voters to indicate the confidence of the ratings entered in the data collection module. This input is entered using the user interface engine module, which processes the information and outputs it to the common data exchange module, which processes it and outputs to the setup module. A representative embodiment of menu choices for this feature in the present invention include confidence ratings on cardinal, ordinal, and nominal scales. For example, cardinal ratings are voter expressions of confidence on a scale from 0 to 100 (low to high). Ordinal ratings use colors (e.g. blue, white, red) or nominal categories (very confident, confident, not confident) to indicate confidence ratings. Cardinal and ordinal and nominal representations can be combined to facilitate use of an interface in the present invention.

An initiator of a group decision in the present invention accesses this confidence option by making a menu selection in the setup module via the user engine interface module. This selection is output to the common data exchange module, where it is processed and output to the setup module, which records the setting in the voting system guidance module. The voting system guidance module automatically outputs the confidence option setting via the setup module and common data exchange module to the data collection module and review module. The data collection module processes the information to configure the data collection module to receive and record the confidence ratings in either quantitative, graphical, color, or nominal representations. When the setup sends the voting system guidance module setting to the review module via the common data exchange module, the review module processes the setting information as input and outputs it to the decision analysis module, which attaches it to the controls governing the matching agenda. When the voting data for this agenda is collected in the data collection module, it is processed and output to the common data exchange, which processes it and outputs it to the review module, where it is processed and output to the decision analysis module. The decision analysis module integrates this information into the computation of a weighted score for each item in the agenda.

This feature is useful in representing complex individual choices (and by implication collective choices) in which the confidence associated with an agenda item in the present invention is used to discount and adjust either a vote allocation or a preference intensity associated with the item. For example, managers must rate subordinates as part of a cross organizational performance review process, but are normally limited by their knowledge of the ratees. Some ratees are new, others are from a different part of the organization and known on the basis of limited contacts, and still other ratees are virtually unknown to the managers who must rate them. Confidence weighting of each ratee's score allows managers to differentiate among strong, moderate, and weak support for a rating and produces a more accurate collective choice representation of the organization's view of a ratee.

A related feature of the voting system guidance module of the decision setup module in block 11 of FIG. 2 in the setup module in the present invention is an option that allows confidence weights to be defined and interpreted as measures of expertise. These measures of expertise can be empirical measures of performance in well-defined tasks. In addition, these measures can be subjective estimates used to weight the expertise of vote or rating data.

This feature is useful in complex tasks in which groups of experts or single individuals must discount evaluations For instance, a group of financial experts can have its expertise measured on the basis of individual records of success in picking investments that meet well-defined criteria. These measures can be used as a profile for discounting the opinions of the group of experts and enable the collective choice to integrate investment preferences and investment skill. This type of insight is impossible to obtain without this feature of the present invention.

This expertise-weighting feature also allows the initiator or participants to assign weights based on their subjective estimates of the skill of each expert. This is useful when a group of experts disagree and the disagreement must be resolved or interpreted to clarify how to proceed. Subjective estimates can be assigned to individuals to gain insight into the non-obvious collective choice implications of weight assignments. The confidence and expertise weighting features of the voting system guidance module are also useful for setting either individual or collective priorities for a to do list. Agenda items can be weighted either by confidence or competence/expertise when the objective is to order a list of tasks that one could do. Agenda items that are ranked high have to receive high preference ratings and confidence or expertise scores. When such lists grow beyond 3 to 5 items, it becomes difficult to integrate such information and gain insight into one's true ordering.

A related feature of the present invention is the option of inputting either intensity of preference or competence/confidence information as ranges instead of a single point. For example, it is often difficult, arbitrary, or impossible to rate a preference, confidence, or competence without losing information about the rater's perspective. Accepting an upper and lower bound from a rater makes it possible to take the median value of the range as an input for a voting system. Such data can be input via the user interface engine via keyboard, mouse, or voice. This functionality extends the value of the present invention to users by making it applicable to fuzzy decision tasks.

Another feature of the decision setup module in the present invention in block 11 of FIG. 2 is that inputs into participant selection, properties, voter identification, and voting system guidance modules of the setup module can be determined collectively. Each list of options in these modules can be called as an agenda to allow participants to reach a consensus on rules that are used in a collective decision making process.

A feature of the present invention is that there are two ways of making data choices for the setup module in block 9 of FIG. 2. These choices are input into the user interface engine module (in block 1 of FIG. 1), which processes them and sends output to the common data exchange module, in block 6 of FIG. 1) which converts the data choices into a proper format and outputs them to the setup module in block 9 of FIG. 2. These input choices can be determined collectively or individually. For many personal decisions, for example, an individual determines all aspects of the initial conditions for group choice. In such cases, the individual inputs data for these conditions in the setup module which processes them, outputs them to the common data exchange module, which outputs the setup conditions to participants throughout the network. However the data choices entered in a setup module can also be determined collectively within the present invention by making use of a data collection module (described below) in which the participants vote on the setup choices. The voting results output in the data collection module are output to the common data exchange, which processes them and outputs them to the setup module, where they become the inputs for a group decision process that are displayed to participants via the common data exchange module.

A related feature of the setup module in block 11 of FIG. 2 in the present invention is that regardless of whether the initiator role is played by an individual or group, initiator choices to configure a collective choice situation can automatically set up all of the modules in the present invention to facilitate processing of information about a particular task. This customization can be done in three ways.

First, an initiator may choose an existing “template” or task model from the setup module menu in block 11 of FIG. 2 (shown in a representative embodiment in block 4 of FIG. 6) and use it as is or modify it through the menu. This can be done from the user interface module in block 1 of FIG. 1 by making a selection in the setup module. For example, typical selections include performance review, allocation of merit raises, and product design. Once a template is either selected or modified and saved, the setup module processes this information and exports it via the common data exchange module to the data collection module and review module, which take the inputs as settings for the display and processing of information in data collection and review modules. In a template, all menu options would automatically be configured in these modules. In the review module, the template would select and carry out options for analysis of voting data in the decision analysis module and the display of decision analysis output (including options for further analysis) in the review module.

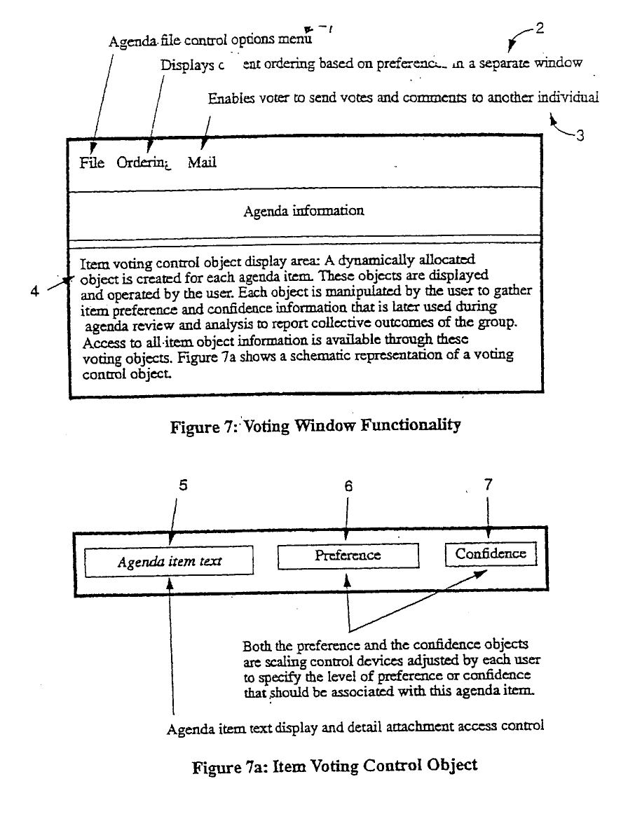

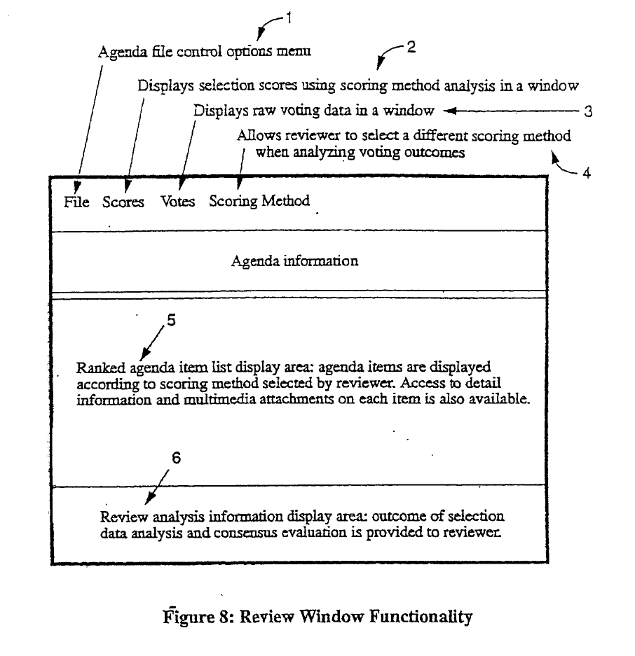

Second, an initiator can configure a template either at any step via the user interface module in block 1 of FIG. 1 in the setup module in block 11 of FIG. 2 (shown in a representative embodiment in block 4 of FIG. 6 or in other modules by selecting the File option from the menu and saving the existing structure as a template (see the representative embodiments in block 1 of FIGS. 7, 7A, and 8).

Third, an initiator can enter a dialogue mode via the user interface module to answer questions in the setup module in block 11 of FIG. 2 about the characteristics of the decision task application. Answers to these questions are processed in the setup module to configure an interface for the setup, data collection, review, and common data exchange modules. This dialogue setup creates configurations or forms that may not be available in an existing template and makes it unnecessary to proceed via the step-by-step procedure for configuring choice processing in the present invention.

Generation of these forms is significant because it provides flexibility in creating new forms that are tailored to the decision task, culture, and information constraints of users.

All three options make it simpler to set up this tool for processing choices. Templates represent a tested structure for handling a decision task that can save time and avoid error for inexperienced users. Saving a constructed configuration and automatically configuring the tool via dialogue provide institutional memory for more experience users and a source of new templates for less experienced users.

A related feature of block 11 of FIG. 2 of the decision setup module in this unique and original invention is the option of selecting real-time simulation of voting situations. These Monte Carlo simulations make it possible to update the collective choice inputs automatically while the voting process is ongoing. The choice of the inputs and the objective of the analysis are selected by the initiator via the user interface engine in the setup module and communicated to the data collection module and review module.

The objectives of the simulation include predicting a group choice on the basis of historical data that describe a pattern of behavior for individual preferences and judgments, predicting the group probability of making a correct choice taking account of preference structures, and modeling the effects of vote trading systems (e.g. fungible voting) (James S. Coleman (1973). “Political Money,” American Political Science Review).

These simulations are significant because they provide insight into group performance that can be used to design measures for intervening to affect collective outcomes. For instance, historical data can be used to plan ahead for contingencies such as indecisiveness or overwhelming support. Similarly, real-time analysis can lead to suggestions either for dealing with ongoing indecisiveness or for pinpointing the conditions under which voting system mechanisms should be invoked. For example, fungible voting's redistribution rule can be gauged and implemented according to such simulations.

Data Collection Module and Decision Analysis Sub-module

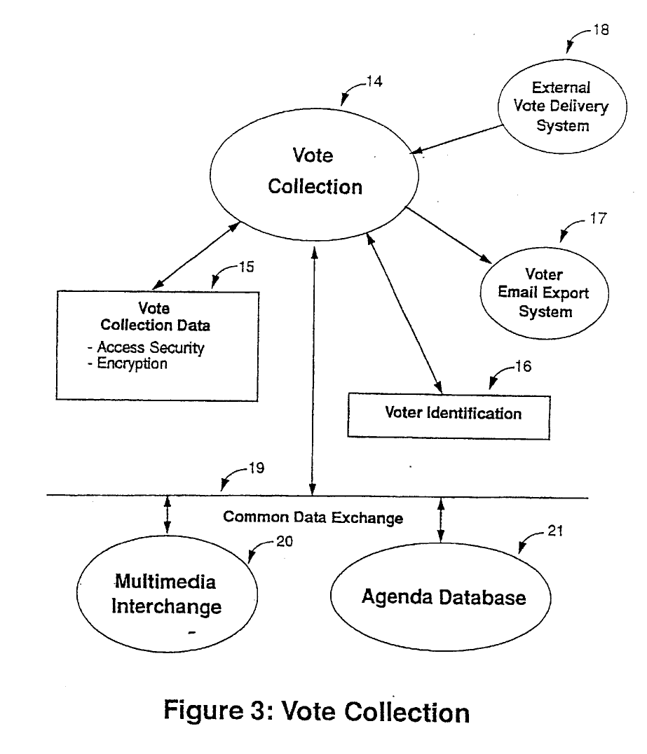

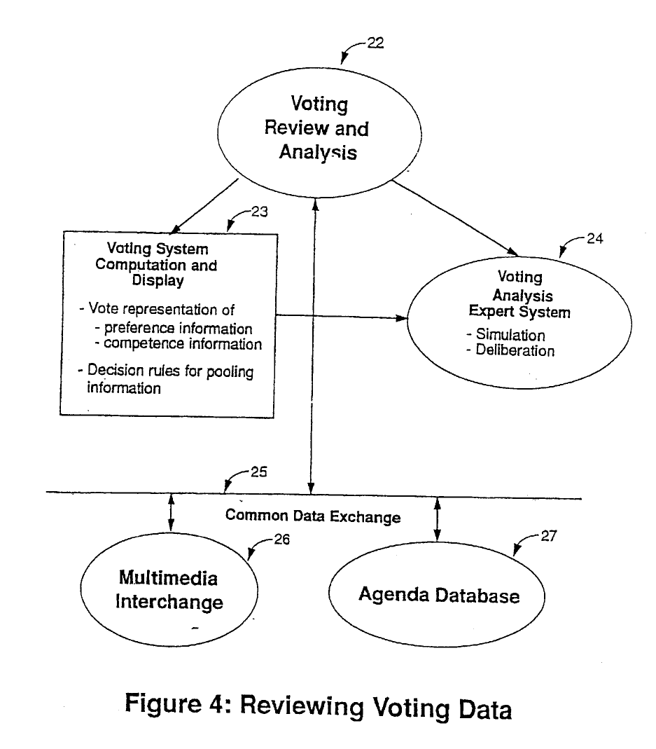

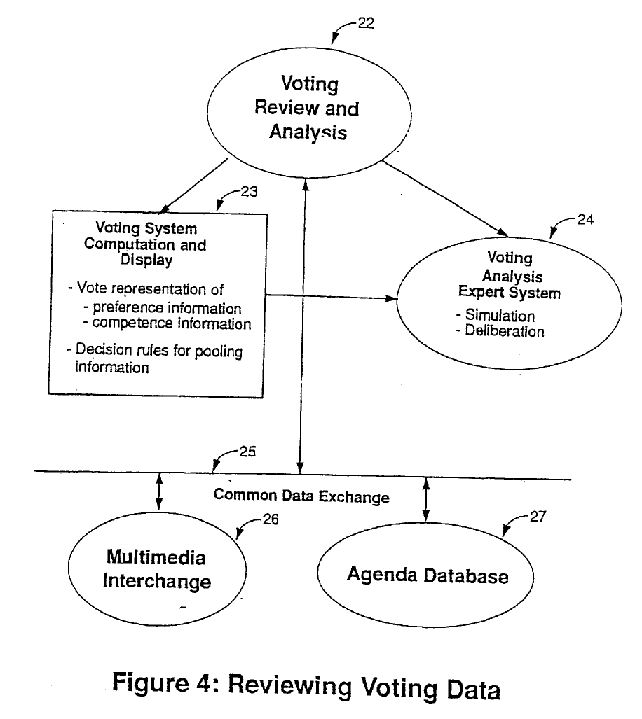

The review module in block 22 of FIG. 4 receives data inputs collected from the data collection module in block 14 of FIG. 3 and processes them as they are received. Preference and judgment data are analyzed in a decision analysis submodule in block 24 of FIG. 4 according to the initial conditions input in the setup module in block 11 of FIG. 2. The decision analysis submodule in block 22 of FIG. 4 processes the data to determine the collective ordering of the choice alternatives in an agenda. This submodule also provides instant identification of the scientific characteristics of a collective outcome such as “Condorcet winner(s).” (Arnold B. Urken, (1988) “Social Choice Theory and Distributed Decision Making,” in R. Allen (ed.) IEEE/ACM Conference on Office Information Systems. Palo Alto. A Condorcet winner is the agenda item with the highest score based on binary comparisons with all other agenda items in each voter's preference ordering. For example, in an agenda containing items A, B, and C, suppose that Jones, a voter, prefers B to A and A to C. This implies that Jones prefers B to C. Jones' preference ordering is normally written: B>A, A>C and, by implication, B>C. Following the Condorcet method, B has a score of 2 (because Jones prefers it to A and C), A has a score of 1 (because Jones prefers it to C), and C has a score of zero (because Jones does not prefer it to any other agenda item).

The Condorcet score for a group choice is found by aggregating the preference orderings of all voters and processing the information as done for Jones. The Condorcet winner is the agenda item with the highest score. The processing of data in the decision submodule shows if the collective outcome includes a Condorcet winner or if more than one Condorcet winner exists. These data results are communicated to participants in the review module numerically, graphically, and verbally. For example, the review module displays the collective ordering indicating ties by highlighting, symbols, or other means. Participants can also view the individual Condorcet ratings by making a menu choice. Graphical representations of the data can be invoked from a menu to gain insight into non-obvious patterns of voting. For example, depending on the controls input in the setup menu, the organizational patterns of voting can be explored if voters make their identities public or even if they vote anonymously. The decision analysis module also outputs a verbal report about the collective outcome based on a rule-based system “filter” that reports the data results created by processing information about individual preferences and judgments under different voting system submodules.

The decision analysis submodule filters the inputs in the voting system submodules according to the controls that have been entered in the setup module. Depending on these controls and the nature of the input data derived from the data collection module, the decision analysis submodule uses a rule-based expert system or artificial intelligence system to guide users in interpreting collective outcomes. A menu provides options for users to choose to explore the outcomes produced by different systems, determining if any of the rules output different results and if so, how those differences are related to the predetermined decision task or objective.

A feature of the decision analysis submodule is that it makes use of a rule-based filter that matches collective choice data with scientific insights. This matching process includes taking the data type and other initial conditions output from the setup module, transforming data into appropriate form for analysis, outputting non-obvious results, communicating and displaying them to the initiator(s) and others in the appropriate form(s) (e.gs. data, graphics, sound, video, animation) according to the specifications entered the setup module in block 11 of FIG. 2.

The decision analysis submodule in block 24 of FIG. 4 also provides broad insight when a collective decision is set up under a predetermined voting system (either because the user knows which system he/she wants to use or that the dialogue boxes in the setup module allow the user to choose a particular voting system). Regardless of the options chosen by the initiator(s), the decision analysis module extracts information output by the data collection module, performs an analysis, and communicates the results of the analysis to participants to improve their understanding of the information presented in the review module.

Depending on the controls that have been input in the setup module, outputs from the decision analysis submodule are reported during the voting process or not until all participants have voted. If analyses are reported asynchronously, the initiator(s) receive feedback and notifications about patterns of collective behavior that are selected in the setup module. For example, the present invention informs the initiator when a weak, strong, and any other type of consensus is identified even though all participants have not voted.

This asynchronous feature of the decision analysis module in block 22 of FIG. 4 operates by processing incoming preference and judgment data output by the data collection module in block 14 of FIG. 3. Preferences are converted into votes in voting system submodules and the output is analyzed to identify' trends in the scores of the agenda items input in the setup module. Trend analysis includes identification of Condorcet winner(s) and other preference aggregation characteristics. The identification process takes account of outstanding voters by analyzing all combinations in which their votes may be cast and by pinpointing the possibilities in which the group's decision objective can be predicted even though some voters have not cast their votes.

The asynchronous decision analysis module includes two subfeatures that provide additional guidance in voting processes. One such feature is analysis of situations in which individual judgments are pooled solely on the basis of statistical description of voter preference orderings. Analytic results such as J.A.N. Marquis de Condorcet (1785), Essai sur l'application de l'analyse a la probabilite des decisions rendues+la pluralit+des voix; and B. Grofman and G. Owen (1984), “Ten Theorems in Search of Truth,” Public Choice) and Monte Carlo simulation results from A. B. Urken (1988) “Social Choice Theory and Distributed Decision Making,” in R. Allen (ed.) IEEE/ACM Conference on Office Information Systems. Palo Alto are used in the decision analysis module to provide feedback to groups about the interpretation of voting data.

For example, Condorcet's theorem provides guidance in setting a is decision rule (the rule that determines a percentage of votes that defines group consensus when voters cast a single vote in a two-item agenda (a “simple binary choice”). In this theorem, the skill or competence of voters, distributed from zero to one, is the major independent variable (though the number of voters can amplify or dampen the effects of this variable on the group probability of making a correct or optimal choice. An actual distribution of voter competencies is measured empirically over a sequence of decisions, contained in a database of measures of long-term performance, based on a statistical sample, or estimated on the basis of expert or subjective judgment. The decision analysis module compares average voter competence and the decision rule to predict the group's probability of making a correct choice. Depending on the average competence of voters (and the number of voters), processing in the decision analysis module will output a message to the review module confirming that a decision rule guarantees maximum group performance or that it should be lowered or raised. In the latter case, the decision analysis module recommends a specific change directly to the initiator(s) or interactively in a dialogue box in which, for example, an initiator enters changes in the decision rule and the decision analysis module responds by approving the change or indicating that it is too small or too large. Another feature of the decision analysis module's analysis of voter competence in the present invention is weighting votes according to empirical measurements or subjective estimates of voter competence or expertise (L. Shapley and B. Grofman (1984). “Optimal Weighting Public Choice). In this protocol, the decision analysis module uses the same initial empirical or estimated individual voter competence data processed using the Condorcet theorem. But the Shapley-Grofman theorem describes conditions under which individuals' votes should be weighted differently or the same. When conditions indicate that the group would have a higher probability of making a correct choice if voter weights are not the same, the ShapleyGrofman theorem provides a weighting scheme for assigning a weight to each person's vote. The scheme is based on the log p/(1-p) where p is a voter's average competence and 1-p is a voter's incompetence.

This weighting scheme is only one of many possible methods for weighting votes that are employed in the decision analysis module of the present invention. The decision analysis module is designed to incorporate a variety of schemes. For instance, anyone looking at data in the review module can input subjective estimates of skill or competence to voters or attach actual weights assigned by experts to their own votes. The decision analysis module processes is these estimates using the Shapley-Grofman theorem and determines what the optimal voter weights should be (given a set of voter competency estimates) or what the distribution of voter competence should be (given a set of voting weights).

This competency analysis feature of the decision analysis module in 20 block 24 of FIG. 4 of the present invention is useful for determining if alternative methods of interpreting and processing data on voter competence make a difference in a group 5 probability of making a correct choice. Making such a determination is pure guesswork without the choice processing insights derived from the present invention. And often the results are counterintuitive. For instance, suppose a poll is taken of experts about a “best” strategy for engineering a new material and that each expert attaches a weight to their recommendations. Also suppose that these experts are rated in a database by other members of your organization and that you assign your own subjective estimates of the experts' competencies. By asking questions in a dialogue box in the review module of the present invention, an initiator or a participant (privileged by data entered in the setup module) can determine if the processing methods make a difference and if so, how significant the difference is. In some cases, for instance, estimates for particular individuals or sets of individuals may be different, but the overall distributions may produce equivalent or nearly equivalent predictions about the group probability of making a correct choice. The present invention makes it possible to ask “what if questions to explore the non-obvious collective consequences of using different methods for processing the data.

A second subfeature of the decision analysis module's processing of competence information in block 24 of FIG. 4 in the present invention is a protocol for interpreting voting processes that include data on voter preference structures or orderings as well as voter competencies or skills. In these situations, each voter is described by an average competence (determined from a database of empirical measurements or subjective estimates) as well as set of preferences for the items in an agenda. The preferences can be ordinal (where it is known that A is preferred to B, i.e. A>B) or cardinal (where it is known, say that Jones, a voter, rates A to be 5 and B to be 1, 50 we can infer that Jones prefers A five times as much as B).

Regardless of the type of voting data defined in the decision setup module in block 11 of FIG. 2 and pooled in the data collection module in block 14 of FIG. 3, the decision analysis module in block 24 of FIG. 4 identifies the initial conditions and processes the information through voting system submodules to provide guidance in the interpretation of the data. An initiator or participant enters queries via the review module to obtain advice. For instance, since ties (where more than one agenda item satisfies a predetermined decision rule or indecisive outcomes (where no agenda item satisfies a predetermined decision rule) reduce a group's probability of making a correct choice, the feedback in the review module guides an initiator or participant by identifying ties associated with the scoring or voting system input in the decision setup module or selected in the review module.

Decision Analysis/Review Module

A related feature of the decision analysis/review module in block 24 of FIG. 4 in the present invention is an analysis of voting data on voter preference structures and competencies in which dual decision rules are employed in pooling and processing voting information. A dual decision rule includes requirements for preference aggregation and group competence that must be satisfied before a collective outcome is, by definition, acceptable. A preference aggregation rule states the percentage of votes that a coalition must obtain to win, e.g. a 51% absolute majority. A competence decision rule describes how dependable the winning coalition is based on criteria such as its past performance (where this measurement is based on empirical data) and subjective estimates. The decision analysis/review module first determines if the preference aggregation requirement is satisfied and then continues to analyze the coalition's competence (Arnold B. Urken and Stephen J. Traflet, “Optimal Jury Design” Jurimetrics (1984).

If a preference aggregation rule is not satisfied under a predetermined decision rule or one that is chosen by an initiator or participant in a “what if dialogue box in the review module, the decision analysis/review module does not continue to analyze the coalition's competence. Instead, the decision analysis/review module automatically processes voting information through voting system submodules to determine if the preference requirement is satisfied under another voting system. If the preference requirement can be satisfied under another system, the decision analysis/review module describes the system in the review module and asks initiators and participants if they want to continue with the analysis of group competence. This choice is guided by online help in the review module that automatically spells out any differences between the original voting situation and the new one based on a different voting system. The second part of this dual decision rule assesses the coalition's dependability by using empirical data or subjective estimates of competence to compute the a priori group probability of making a correct choice.

The decision analysis/review module carries out this computation using the Condorcet and Shapley-Grofman theorems, which provide a comprehensive assessment of the maximum group probability of making a correct choice. For instance, suppose that we require that a coalition be reliable 80% of the time and the decision analysis module reports to us in the review module that our coalition does not satisfy requirement Then the decision analysis module will present options in the review module dialogue boxes to continue interpreting the data. For example, the decision analysis module will automatically recompute the voting data to find out if a subset of voters can be identified who meet the competence and preference requirements.

This analysis is significant because it provides a non-obvious way of seeing that the group may have actually achieved its objective even though a conventional analysis suggests that the objective has not been obtained. Another feature of the present invention is a decision analysis/review module that provides guidance when the decision objective is to select more than one agenda item from three or more agenda items. For instance, suppose two items must be selected from an agenda of ten items. In this situation, the decision analysis first searches for the two items that have the highest and next-highest scores in the voting method that is input in the setup module or entered in the “what if option in the review module. This search also automatically processes the voting information through all voting system submodules. The results of this processing are used as output in the decision analysis/review module to inform initiators and participants about the strength of the consensus.

If there is a tie or an indecisive outcome that occurs in pursuing the decision objective of finding the top two of ten agenda items, the decision analysis module automatically tailors the processing of information. For example, suppose that A, B, and C are in a three-way tie. The decision analysis module determines if any of the tied items is a Condorcet winner or has any other characteristic that can be used to resolve the outcome. Many possibilities are accounted for. If A and B are Condorcet winners, this data is output in the review window by highlighting A and B in a collective outcome list and presenting written and oral interpretations of the display. If none of the tied agenda items are found to be Condorcet winners, the decision analysis module processes voting inputs to determine if there are any other non-obvious characteristics in the voting data that can be used to resolve the tie. For instance, if A is found to be preferred to C under a different voting system, the decision analysis/review module communicates this insight to initiators and participants in the review module.

This feature is significant for initiators and participants because the feedback output from the decision analysis module provides insight that enables the group to resolve a tied outcome that would otherwise involve inefficient deliberation and possible selection of C, a weak choice, as one of the two outcomes preferred by the group. The same type of feedback is provided to avoid error when the group decision objective is to select one agenda item. For example, if A and B are tied in a two-item agenda and the decision analysis module determines that A is the Condorcet winner, this information is communicated to participants and initiators in the review module to enable them to select the strongest choice. Without this insight, groups typically resort to incorrect, distorting, and arbitrary methods of resolving a tie such as flipping a coin or allowing a designated or predesignated person(s) to cast a tie-breaking vote.

Another related feature of block 24 of FIG. 4 in the present invention 30 is the resolution of ties, regardless of the number of agenda items, when a two, three, or n-way tie occurs in a collective outcome where the objective is to select a single agenda item, the occurrence of a tie is seen as a sign of failure when, in fact, it is not. For example, a two-way tie might include two Condorcet winners, so the group could flip a coin or allow an arbitrary choice without making an error. This type of insight is impossible to gain without the decision analysis module in the present invention. Gaining such insight provides flexibility in implementing group choices. For example, this feature allows an initiator or group to evaluate the tied alternatives by taking account of factors external to the collective choice that may be important to the individual or organization (e.g. cost, timing, etc.).

Another feature of the decision analysis/review module in block 24 of FIG. 4 in the present invention is the provision of a verbal assessment of the strength of the consensus that underlies the collective outcome(s) produced. Verbal reports, based on the rules underlying the voting systems filter used in the decision analysis module, are produced by the decision analysis module and displayed in the review module. The rules of a voting filter are categorized according to the amount of detail provided about voter preference structures and judgments. When collective outcomes are consistent under all voting systems, a “maximum consensus” is reported. Gradations of verbal evaluations are reported between this extreme and a plurality winner produced under one person one vote voting when no other voting systems yield the same result. Online help (including tutorials) is provided in the menu.

A related feature of the decision analysis/review module in block 24 of FIG. 4 in the present invention is simulation of a completed voting process under different conditions. This simulation, unlike the real-time simulation options contained in the setup module, are concerned with retrospective analysis of a completed social choice process. This feature is accessed when a user makes a selection in the detail option in the review module via the user interface engine module and gains access to “what if options for reinterpreting one or more collective outcomes. These options include the possibility of comparing the filtering of collective outcomes for the same agenda produced by two or more groups, reprocessing of voting information based on data derived from the partial privacy options contained in the setup module, and ad hoc selection of artificial groups based on criteria such as preference structures or subjective or objective measures of skill or expertise.

This feature is significant because it allows integration of choice processing information from historical archives or from groups that carried out the same decision task without realizing it. The same feature allows reinterpretation of the same data without additional coding or data manipulation to facilitate exploratory analysis of a task. For instance, in performance review, reprocessing of voting information based on division, section, experience band, or other criteria enables an individual or group to ascertain if differences exist and what the underlying pattern of such differences is. Ad hoc formation of voting scenarios can provide the same insight into the data.

This feature is also significant because it helps pinpoint differences of opinion in an organization. This important because once the organizational parameters of disagreement have been identified, the setup module in the present invention can be used to establish new agendas to explore new options for gaining agreement and yielding stronger consensus.

Another feature of the simulation options in block 24 of FIG. 4 in the decision analysis/review module of the review module in the present invention is the determination of a best fit between voter preference structures and collective outcomes. This fit can be determined in two ways. If preferences are ordinal, statistical tests such as the Kendall Tau tests can be used to reduce the information about voter preferences to find out which subset of individual preferences accounts for 95% or more of the information. Then the identified subset can be compared with collective outcomes produced by different voting systems to find the highest correlation.

A user can access this analysis from the decision analysis/review module via the user interface module on an ad hoc basis or on an automatic basis. In the first case, a user may just want to explore or be prompted to investigate because his/her expectations or most preferred choice was not selected. In the second case, a user wants the outcome checked to make sure that the results are reliable. In either case, the request is processed and sent to the decision analysis module, which processes it and outputs the results in a display window in the review module.

This feature is useful in giving an objective analysis of “the best” choice of a voting system either before or after the data have been collected. Before data have been collected, conjectures about the aggregate characteristics of voter preferences or actual measurements derived from historical data can be used to identify the initial conditions for the analysis. The result of the analysis is not necessarily the choice of a single system, but identification of more than one system and a recommendation that takes account of the relative performance of the voting systems. After data have been collected, the data for a specific case can be analyzed retroactively to provide the same insight.

A related feature of the decision analysis module in the decision analysis/review module in block 24 of FIG. 4 of the present invention is an analysis of the relationship between individual and group competence under different voting systems. In this case, the Condorcet, Shapley-Grofman, and Monte Carlo simulation results (that can be conducted in real time) are used to determine the maximum difference of individual and collective behavior. Consequently, statistical criteria for determining the worst fit and the direction of the distortion are used.

If the decision situation permits collection of data for preferences and 5 competencies on a cardinal or ratio scale, this type of simulation analysis can be done with more powerful statistical tests. If either ordinal or cardinal data are not available, a user can use the user interface module to input guesses to investigate “what if scenarios. These data can be specific data by voter (useful in small group situations) or aggregate characteristics (more useful in large voting bodies). In both cases, differences in scenarios that are run to investigate hypothetical differences are displayed in multimedia displays in the decision/analysis review module.

This analysis is useful in two ways. First, it provides insight into choosing a voting system before or after data collection. Second, this analysis can be combined with the “best fit” analysis to identify nonobvious tradeoffs between taking account of voter preferences and taking account of voter judgmental skills. For example, a committee making investment decisions would benefit from looking at its choice process in three ways to guide its work: best preference fit, worst competence fit, and preference/competence tradeoff This information can be useful to a committee in its deliberations, but it can also be useful to a superior (or another committee) who receives the committee's report and must decide how to interpret it. A related feature of the simulation analysis in the decision analysis/review module in the review module in the present invention is the creation of databases that identify factors that explain deviations in individual and groups from predicted behavior under different voting systems. If the data are representative of ongoing decisions, they can be used to identify' voting behaviors in choosing a voting system for a future decision or reassessing a completed collective decision. In both cases, background factors can be identified either for groups (e.g. either by division, branch, sales or profits) or for individuals (e.g. education, job, income, psychological, preference structure, and competence) to determine the consequences structuring a choice. Group and individual characteristics can be used to analyze situations in which voting options are limited, but the composition of the group is not. For example, ratio comparisons may not be reliable (in general or based on past behavior), but the makeup of a task force may be flexible. This feature allows a group or individual to build artificial voting bodies based on simulation results that provide insight into expected characteristics of one or more collective outcomes. These characteristics include measures of strength of consensus and decisiveness appropriate to the task.

This feature is useful in situations in which a group is engaged in making choices with common substantive and logical characteristics. For example, investment, engineering, and marketing choices have these characteristics.

A related feature of the simulation options in the decision analysis/review module in block 24 of FIG. 4 in the review module of the present invention is the ability to explore a voting analysis with a graphical or voice interface that represents a user's questions. This feature is “steering analysis.” For instance, to probe the strength of a consensus under preference aggregation, the dimensions of a probe can include the strength or weakness of a consensus, the decision rule (e.g. plurality, majority or even more complex rules including group competence or other social characteristics such as cost), and the number of voters. These dimensions can be accessed graphically or by voice in the decision analysis module is of the review module via the user interface engine module. The decision analysis module responds to inputs that are nominal (e.g. strong consensus), ratio comparisons (e.g. maximum consensus), and ordinal comparisons (stronger consensus) to process the information and output the result data in the review window using multimedia information appropriate to the task.

The steering analysis feature also works with dimensions of analysis such as competence (alone) or competence combined with preference structure and background aggregate data if available (by organization or individual). In this mode, the objective of the analysis is to identify one or more ways of selecting an optimal choice.

In both forms of steering analysis, the definition of the objective itself can become a dimension of analysis. For instance, in assessing voter skills, the overall objective might be to select the three optimal choices from an agenda. In this case, a dimension of exploration would include choices such as “one out of three optimal choices” and “more than one out of three optimal choices” as inputs.

Similarly, in evaluating the prospects for consensus, exploration could include the objective of gaining a majority consensus on three items in a ten-item agenda. So typical exploration choices would include “more than one out of ten choices” and “three out of three choices.”

A related feature of steering analysis in block 24 of FIG. 4 in the 35 present invention is that it outputs options to the user as dimensions and directions along various dimensions are changed. Multimedia output from the decision analysis module to the decision analysis/review module allows the user to identify one or more voting systems that can be used to achieve the objective(s) used in the simulation.

The steering analysis feature in the present invention is useful because it simplifies the process of exploration for users, particularly those who do not have the time or skill to set up a quantitative analysis. This form of analysis can also be used in query mode by allowing a user to input specific sets of voting system requirements and receive a report about the feasibility of using such requirements.

Another feature of the decision analysis review module in block 24 of FIG. 4 in of the present invention is hypertree, the creation of a hypertext database block 27 of FIG. 4 relating collective decisions systematically to describe the history of choice behavior among users. This database can show the relationship between a current decision and past decisions along dimensions including topic, time, and characteristics of the decision.

This hypertree feature enables users to keep track of trends and choices that are normally described in terms of influence diagrams or decision trees. Influence trees are limited because they do not provide guidance about how to make a decision; they simply report the role of factors in the decision making process. Decision trees, in contrast, describe the logical process of producing options, but usually provide a limited view of what has happened in comparison to what could have or should have happened. Hypertree combines keyword and character strings, background data, and voting records to identify reasons and influences in the decision making process.

Another feature of the decision analysis/review module in block 23 of FIG. 4 is that it includes coordinated displays that communicate multimedia, multipurpose information to participants so that they can use it to deliberate about the interpretation of collective choice results.

The flexibility and power of modem operating system and windowing environments make it possible to use computers as more than super-adding machines that simply aggregate data based on a voting algorithm. The present invention provides an environment, embedded in a unique and original software tool, that constitutes an information base for decision analysis.

“Fungible” Voting and Theoretical Techniques

Another feature of the present invention provides an apparatus in block 11 of FIG. 2 for the implementation of voting methods or systems that have always been theoretically possible, but have not been used because no systems or mechanisms have been devised to handle the presentation and analysis of information, accounting, cost, and security problems. An example of this feature is establishment of an apparatus to support fungible voting, under which votes can be traded and saved like money.

Under this system or method, for example, voters are allowed to cast more than one vote per decision. Therefore they must decide how to allocate their vote endowment or resources taking account of the results of reallocating votes among decisions themselves as well as taking account of the consequences of trading votes with others to influence collective outcomes. Feedback about outcomes as well as trends in ongoing decisions is provided in the present and unique invention to guide either individuals or groups about how to invest their resources. For instance, this feedback can guide voters in determining when to vote and how many votes to allocate.

Similarly, under fungible voting, rules for reallocating votes allocated to a collective decision play a role in creating social stability (e.g. either by not allowing some voters to dominate or by preventing others from failing to achieve any positive payoffs because they are always outbid in collective decisions. Reallocation rules determine if votes should be reallocated, when they should be reallocated, and how they should be reallocated. This dynamic analysis of fungible voting makes it possible to automatically regulate the redistribution of votes after each collective decision to balance voter gains and losses derived from the voting process.

It is important to note that this function goes beyond simple aggregation of information by providing background analysis tailored to provide insights to users for making intelligent decisions in a dynamic environment. This function also keeps track of voting transactions as well as the costs of making transactions including communications costs and broker costs.

This feature is significant because there are many unused voting systems that have desirable theoretical characteristics such as stability (James Coleman, “Political Money.” American Political Science Review, 1973) and efficiency (J. M. Buchanan and G. Tullock, (1962, The Calculus of Consent, Ann Arbor: University of Michigan Press) and D. C. Mueller (1989), Public choice II, Cambridge University Press). The complex and dynamic character of these systems requires computer-mediated guidance to identify trends and determine the proper time to begin actions such as redistributing votes.

External Interfaces

Another feature of the present unique and original invention is a version of the modules that make up the invention that are tailored to situations in which nodes, machines, or processes are interpreted as if they were voters. In this metaphor, the setup, data collection, and review modules as well as the common data exchange module provide a system for processing information about preferences and judgments from artificial actors (defined and created in software) that are processed to produce collective outcomes that efficiently and effectively resolve conflicts that arise in computer networks. (Urken, 1988, 1990) Explicit use of voting methods has been applied to provide consistency (H. Garcia Molina and D. Barbera, (1985). “How to Assign Votes in a Distributed System,” Journal of the Association of Computing Machinery), manage distributed databases (R. van Renesse and A. S. Tanenbaum (1986). “Voting with Ghosts,” Proceedings of the Eighth International Conference on Distributed Computing Systems), and reorganize failed networks (D. Barbara and H. Garcia-Molina (1987), “The Reliability of Voting Mechanisms,” IEEE Transactions on Computers), but none of these applications has made use of the voting systems for filtering information contained in the present invention. Moreover, the present invention's filtering of information makes it possible to extend the applications of voting methods to a greater scope of tasks.

For example, a feature of the present invention is to provide consistency in computer networks by processing preference and judgment information of nodes to enable a group to achieve its objective. This is useful, for example, because voting systems based on “coteries” include no way of breaking ties. In the present and unique invention, however, ties can be avoided by changing the voting system. This is useful because it makes the process of searching for consensus among nodes more efficient. This filtering can also be used to improve the reliability of the decision rendered by the voting nodes (Arnold B. Urken, 1990, “Distributed Control via Agent Voting” in R. Allen (ed.) Proceedings of the IEEE/ACM Conference on Office Information Systems). This is useful because it accommodates the assumption that nodes are imperfect and compensates by choosing a voting system by processing the preferences and judgments nodes in the present and unique invention. Coterie processing and other voting techniques rely on the assumption that if a node is working (or “alive”), it is perfectly reliable. This strong assumption, limited by the fact that nodes can all be alive and render imperfect choices, is unnecessary in the present invention.

Another example of the usefulness of the present invention is in phone routing as a form of “dynamic routing” in the voting process is regulated to control the congestion and load balancing of a phone network. By distributing the voting process so that nodes form preferences (inversely related to the amount of congestion on a linkage) and judgments (from their experience) based on their positions in network linkages for assigning an incoming call, the efficiency of phone routing can be improved. Moreover, this technique serves as a basis for creating a self-regulating phone network. (Arnold B. Urken, “Distributed Control via Agent Voting,” Proceedings of the IEEE/ACM Conference on Office Information Systems, MIT, 1990.

Another example of the usefulness of the present invention is in managing access to resources in a network. This application provides an alternative to the first come, first serve queuing that is used to resolve conflicts among processors about access to printer, disks, tapes, faxes, network gateways, and other resources. Each of these conflicts involve a group decision situation in which nodes and processes can formulate priorities according to internal rules and engage in a group decision making process mediated by the present and unique invention (Arnold B. Urken, “Asynchronous Voting and Consensus in Computer Networks,” Paper Presented at the Annual Meeting of the American Political Science Association, Aug. 31, 1991).

How the Features are Employed by a User

Choice processing in the present and unique invention involves transactions identifiable in terms of common logical characteristics including the role of the decision maker, the decision task or objective, the timing of the decision, and the analysis of voting information. This description of the invention is based on typical voting situations that embody these characteristics. The following descriptions of the invention first assume that the actor, agent, or user is a human who opens a role. Then the operation of the invention is described for nodes or processes as if they were actors, agents, or users.

An actor opens a role in FIG. 1 at block 1 of the User Interface Module in the group decision making environment. The actor can choose among initiating a collective decision in block 2, voting or selecting in block 3, brainstorming in block 3a, or reviewing a decision in block 4. Opening a role can be done by uttering a command, typing in information on a keyboard (e.g. at a command line prompt), using a mouse, roller ball, pen, or other mechanical device, or employing any other communications mechanism. Opening a role can also be done from within another application that provides functionality that is compatible with the present and unique invention.

If an actor chooses to initiate a decision in the present and unique invention in FIG. 1, this choice is processed in block 1 and communicated to the Common Data Exchange module in block 6, which processes and sends it to the Setup Module in FIG. 6, where it is processed to produce a display of information that presents a menu' of options contained in blocks 1 through 13 The actor uses the User Interface Module at block 1 to input choices via the Common Data Exchange at block 6 to set up a collective decision. Alternatively, an initiator may select a preconfigured set of inputs from block 1 that is a model or template. This template, which may be the saved results of menu input of initial conditions for a collective decision, may itself be modified.

When inputs are entered via a menu in block 2 of FIG. 1, they are processed by the Setup Module in FIG. 6 and output to the Data Collection Module in FIG. 7 and Review Module in FIG. 8, where they are processed and used as inputs for the parameters of processing of voting information. The following inputs are entered in FIG. 6 into the system in the following default order, though an initiator can modify this sequence.

An initiator of collective decision must first create an agenda by choosing the File option at block 1 in FIG. 6, selecting the New option. After an agenda name is added, a description of the agenda topic can be input in the display of the name in block 5 of FIG. 6 by double clicking on the name and filling in a popup window. Agenda items are added by entering a name in block 7 of FIG. 6 and then selecting the Add option in block 8 of FIG. 6. Selecting the Add option displays the item in a list in block 6 of FIG. 6. The initiator can then select an item and fill in detailed information by selecting the Detail option in block 12. Attachments of sound, graphic, animation, video, and multimedia documents are made via the menu at block 14 of FIG. 6. These files, located anywhere on the network, can be accessed by entering an address or entering the name or part of the name of a file to be searched by a daemon across the network. The daemon makes use of a filter in block 13 that allows a search by file type across the network that produces a list of file choices that can be imported. Attached files or pointers to their network addresses are stored in a database contained in block 7 of FIG. 1. Agenda items can be edited by making use of the Delete option in block 9 of FIG. 6, the Change option in block 10, or the Undo option in block 11. Agendas can be modified by entering their names in block 7 and selecting the same editing options.

If an initiator tries to set any of the setup inputs before opening an is agenda, a window opens in block 6 with a reminder that an agenda must exist before any other conditions are set.

Next, according to the default sequence, the initiator sets the properties of the collective decision in block 2; who will participate, how they will be identified, and when they will participate. Participants can include the whole network, random sets of network users, random sets of users with specific demographic or other characteristics, identifiable groups of individuals (e.g. a division or unit of an organization), nominal groups (e.g., a task force or project team), or groups selected on an ad hoc basis by the initiator by scanning a listing of all users. Then the initiator sets voter identification options in block 2. These options allow participants to act frilly identified, anonymously, or with gradations of anonymity. The latter option allows a participant not to divulge a name, but communicate other information (e.g. sex, job description, income, and other characteristics).

The next default input is the scoring or voting system in block 3. If the 30 initiator wants a specific voting system, a selection can be made from the menu in block. Different levels of help on choosing a scoring system are available from the menu. Descriptions of systems facilitate initiator choice, but the initiator can enter a dialogue mode in block 2 to obtain further guidance in choosing a voting system. This guidance is based on collecting information about the parameters of the collective decision (e.g. the number of voters and the decision task(s)) so that a choice of systems or a specific system can be recommended in a display in FIG. 6.

If guidance in choosing a voting system involves a specific situation or a sequence of decisions in which other parameters of a voting process can be analyzed, the Review module [FIG. 8] opens automatically to allow the initiator to analyze the non-obvious implications by selecting menu options.

In a single collective decision, for instance, the initiator can enter data in block 4 of FIG. 8 to explore “what if” scenarios associated with the preferences and competencies of the voters. (This analysis is possible because the initiator has already specified the group in block 11 of FIG. 2 shown in a typical representation in block 2 of the Setup Module, [FIG. 6]. These simulations allow the initiator to analyze and formulate expectations about the incidence of ties, indecisive outcomes, Condorcet or Copeland-efficiency (gauging the strength of the consensus) under different systems, and different ways of weighting votes. In each case, a single decision is randomly selected from the scenario composed by the initiator in FIG. 8. This analysis makes it possible to scrutinize the implications of complex decision tasks and gain insight into the choice of a voting system.

If voters have established preference profiles in block 7 of FIG. 1, this data can be used as input for a voting system analysis in block 4 of FIG. 8 to guide the choice of a voting system. Similarly, if experts have established records of performance, measurements of their reliability contained in block 7 of FIG. 1 can be incorporated into the analysis.

For a sequence of collective decisions, the initiator can select a simulation that is based on 1) conjecture or educated guesses entered in block 4 of FIG. 8 or on 2) empirical estimates of patterns of behavior derived from a database in block 7 of FIG. 1. In the first case, the simulation randomly selects a number of cases (specified by the initiator) and repeats the selection process enough times to yield statistically reliable predictions. In the second case, the simulation makes use of measures of preference structure and competency to provide the initial conditions for the analysis.

In both cases, the simulation allows the initiator to explore what 30 happens if decision requirements for preference aggregation and competence are defined (e.g. 51% of the votes plus an a priori group probability of 0.8 of making a correct choice). For simulations that take account of measured past behavior or conjectures about long-run patterns of behavior, this analysis compares measures of collective competence including the Condorcet “jury theorem” and the Shapley-Grofman theorem to determine if there is a difference. Differences are presented in a popup window in FIG. 8 to allow an initiator use the information in selecting a scoring system.

All of the simulations provide the initiator with reports comparing the analysis in quantitative and qualitative terms. For example, these reports show the probability of a decisive outcome (under different decision rules such as majority) allowing the possibility of partially achieving a goal (e.g. selecting two out of ten choices, but not the three out often choices required). These reports, displayed in block 6 of FIG. 8, also take account of strength of the consensus and, if appropriate to the decision task, competence. Tradeoffs among these results are highlighted in these reports.

When the initiator selects a voting system in FIG. 8, the selection is displayed automatically in block 3 of FIG. 6, FIG. 8 is closed, and the input of initial conditions by the initiator continues.

Next in the default sequence of setup inputs block 2 of FIG. 6 is timing. The beginning and end of the collective decision making process is specified for decisions that are synchronous (same time) or asynchronous (different time).

The next default input in block 2 is the privilege to edit the agenda. This privilege is reserved for the initiator unless it is shared with some or all of the participants. If sharing is selected in block 2, then brainstorming mode is automatically selected. This selection means that when the setup inputs in FIG. 6 are completed and the agenda file (to which all of these settings are attached) is saved and closed in block 1 of FIG. 6, participants with the editing privilege can add items to the agenda or delete items that they have added.

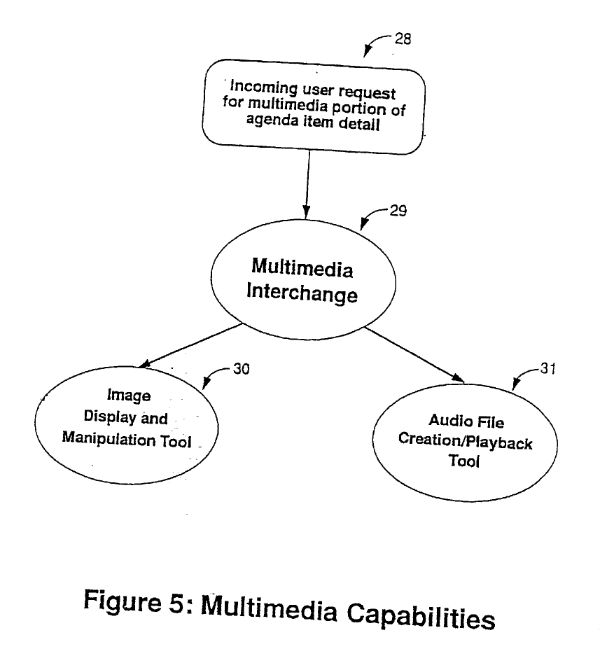

If the initiator has set up the privileges in FIG. 2 to allow participants to review the results of the vote, the review module in FIG. 8 can be accessed. This access will automatically be provided once a participant has voted and saved the scores. Regardless of whether a participant is in FIG. 2 or FIG. 3, information analyzed in FIG. 4 can be obtained by providing a voice command, graphical interface command, or command line command via FIG. 5. If a participant is currently a member of only one ongoing agenda, analysis of data for that agenda will automatically be displayed in [FIG. 4]. Otherwise, a directory of agendas a participant is working on or has worked on will be displayed to allow the user to choose which agenda(s) to review.

When the roles of initiator, selector, or reviewer are played by nodes or processes instead of humans, the invention operates in the same way, though the interface for obtaining and sharing information may differ. If an intelligent robot or similar actor is programmed to act as if it were human, blocks 2, 3, and 4 of FIG. 1 (represented in FIGS. 6, 7, and 8) would operate in the same way. However if the 35 intelligent actor is software defined, only, the input and output would be tailored to predetermined rules for making decisions that are part of a template designed for one or more specialized tasks. Such tasks include the same logical characteristics of agenda creation, scoring system setup, data collection, and decision analysis. These tasks include distributed database management, reorganization of a failed network, resolution of conflicts about scarce network resources, and routing of phone calls.

In a typical task, an initiator makes use of block 1 of FIG. 1 to create the initial conditions in block 2 for a collective decision that is processed in the data collection phase in block 3 and review phase in block 4. In phone routing, for example, the options in FIG. 6 are preset by a programmer to allow maximum flexibility in the choice of a voting system to enable the network to achieve goals such as load balancing, minimum average delay, and responsiveness to radical changes in demands for service. To facilitate goal attainment, a template is created on the basis of simulations to identify the conditions under which data about preferences should be represented in different ways and analyzed to guide decision makers.

As calls arrive to be routed, each node formulates preferences by inversely rating each choice for routing a call. Votes are then allocated according to the rules. Preference ratings and votes are broadcast throughout the network so that each node obtains the same voting information and processes it. Here review of the data can work in 3 of FIG. 7 in this way for a particular agenda. Alternatively, in the icon or voice interface in block 1 of FIG. 1, the receipt of a mail message can be indicated either by a flashing add-on to the icon or by repeating a voice-message reminder. Either of these notifications allows a participant to access the mail message(s) by touching the mail portion of the icon with a mouse, pen, or finger or by responding with a vocal command.

Only the initiator of the brainstorming session can “enable” voting in block 5 of FIG. 6 50 that participants can begin evaluating the list by scoring or voting on the agenda items in blocks 5, 6, and 7 of FIG. 7a. However this choice, like all the other menu options in the setup module, can itself become an agenda that participants use in two ways. First, each node can act as if it had initiated a decision and were acting to pool and analyze the information in an advisory way. Since all nodes have the same information and operate on it with the same rules, there is no clear distinction between individual (node) and collective decision making. Second, data can be transmitted to a node designated as the official vote recipient and data analyst.

Brief Description of the Pseudocode

The logic of the exemplary processor is illustrated in the following sequence of steps:

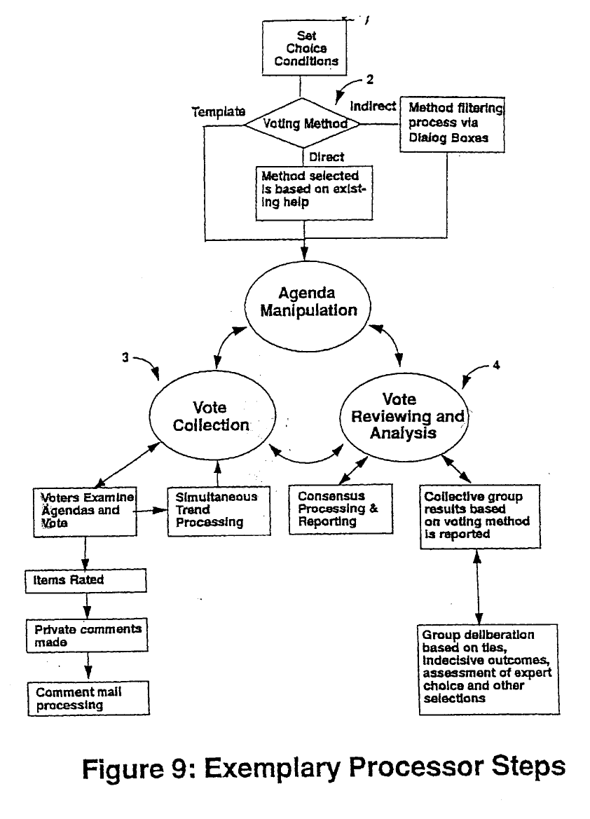

1. Set choice conditions: timing, notifications, privileges, agenda items, 5 background information in block 1 of FIG. 9.

2. Determine voting method in block 2 of FIG. 9: if method is directly chosen based on existing help, use dialogue boxes to guide choice to make maximum filtering of information available for monitoring the choice process and reviewing the collective outcome.

if method is not directly chosen in block 2 of FIG. 9, use dialogue boxes to select the best method of voting and provide maximum filtering of information available for monitoring the choice process and reviewing the collective outcome.

if a template is chosen for a particular task in block 2 of FIG. 9, the is the voting method is preset.

3. Voters examine agendas and vote in block 3 of FIG. 9: information may be added to agenda item detail windows and data from public windows can be copied to private comment windows for comments; private comments can also be shared votes allocated in a way that is consistent with the settings. depending on setup conditions, the group

can opt to brainstorm to modify the agenda by invoking the brainstorming template in block 2 of FIG. 9 and can move back and forth as appropriate between brainstorming and voting in block 2 of FIG. 9

votes and private comments can be mailed to share information in block 4 of FIG. 9.

4. Review of voting outcomes in block 4 of FIG. 9:

in process reports are made that indicate trends based on a comparison of different voting methods.

voting outcomes for different systems are compared to assess the strength of a consensus based on the inferences that can be drawn from individual and collective ordinal and cardinal ranking information. Verbal reports and individual and collective scores are provided.

individuals and groups can review the interpretations of data and obtain guidance to deliberate on ties, indecisive outcomes, assessment of expert choice, and special situations such as the selection of more than one choice from an agenda. Each report is based on the comparison of voting outcomes in all of the voting algorithms contained in block 4 of FIG. 9.

Glossary, Nomenclature, and Definitions

The following descriptions are presented to clarify the generic characteristics of the present invention for gauging group choice processes. “Voting” is a metaphor for actions that communicate information about preferences and judgments about a set of choices and enable us to define a collective outcome. There is no generally accepted standard scientific notation for voting methods that provides a consistent guide between scientific analysis and practical usage of voting methods. Our experience in developing this invention indicates that “voting” activities may be more appropriately presented using terminology such as “selecting” or “choosing” and “scoring system” in the interface. For this reason, the invention includes the option for using different descriptors for parts of a voting process. Although verbal metaphors such as “voting with one's feet” are still commonly used, quantitative representations of voter preferences and judgments involve algorithms that have been discovered and lost several times (see I. McLean and A. B. Urken (eds.) Classics of Social Choice (in press) University of Michigan Press). Since the eighteenth century, however, these algorithms have been named and formalized mathematically in axiomatic, algebraic, and probabilistic terms.

The present invention makes use of the information about (and derived from) voting algorithms in the context of three stages of a group decision process: either 1) the formation of voter preferences and judgments, 2) the filtering and representation of preference and judgment information by voting rules for allocating votes, or 3) the aggregation of allocated votes by group decision rules (e.g. majority rule).

The preference information that serves as input for a voting process can be measured or defined on either a cardinal or ordinal scale. Cardinal inputs are numbers or numerical comparisons that indicate how much more one alternative is preferred than another. Ordinal preferences simply show if one alternative is preferred to another and do not measure intensity of preference. Ordinal comparisons can include nominal classifications such as “good” or “average” that implicitly indicate that one set of classified items is preferred to another.

Complex voting systems such as “fungible voting,” where votes can be saved and traded like money, involve dynamic patterns of action that have not been supported by mechanisms such as those provided in this invention. The present invention not only provides a structured framework for supporting such systems, but also offers dynamic analyses that guide users in making decisions about the best use of their resources in pursuit of their objectives. These systems implicitly include the notion of same time (synchronous) and different time (asynchronous) action.

In the present invention, the notion of an “agenda” is a fundamental organizing concept for structuring, a group decision making process. Sometimes the term “agenda” is used to describe the substantive topic of a choice, but the system and method used in this invention defines an “agenda” to include attachments that explain what the choices are (including multimedia attachments that provide background information), who makes the choices (including different definitions of voter identity consistent with gradations of privacy as well as privileges set by the initiator), and how the choices will be made (including the timing of the choices and voting systems used to process information). This organizing concept provides a basis for treating an agenda as a collection of objects both in abstract terms as well as in computer programming terminology. In computer programming terms, an agenda is not only an object for “object oriented programming,” but is also an object in the sense of an Electronic Data Interchange (EDI), a standard object or format for communicating voting information so that it can be analyzed in the present invention.

It is important to note that the use of the terms “multimedia” and “multipurpose” are not necessarily redundant. The latter term, associated with standards such as the MIME (Multipurpose Internet Mail Extension) standard, is used to indicate the purpose of a part of a message that includes non-textual information. In contrast, “multimedia” refers to the use of more than one medium to convey information without being more specific. The description of present invention follows the emerging convention of using both terms to communicate both to audiences that understand the general idea of messages that incorporate more than one medium and to audiences that expect a more specific description of the relation between the use of a computer-mediated medium and the purpose of a message.

What is claimed is:

1. A system for making a collective choice, said system including:
(a) a communications network;
(b) one or more terminals coupled to said network; each of said one or more terminals having an input device;
(c) one or more servers coupled to said network;
(d) at least one database associated with said one or more servers; said at least one database having storage fields for receiving and providing data;
(e) an input data object generator for generating a number of input data objects having input fields associated with related storage fields of said at least one database; for delivering one of said number of input data objects to each of said one or more terminals so that each of said input devices can enter input data reflecting an individual choice into said input data object and for sending said input data object to said at least one database for said input data to be received thereby;
(f) an output data object generator for generating an output data object having output fields associated with one or more of said related storage fields of said at least one database; said at least one database to provide output data to said output data object; and
(g) a choice generator for receiving and manipulating said data from said output data object to generate a result of a collective choice.

2. A system as in claim 1 further comprising a module for selecting at least one terminal from among said one or more terminals.

3. A system as in claim 2 further comprising a module for masking the identity of said one or more terminals from an administrator of said system.

4. A system as in claim 1 wherein each of said one or more terminals further includes a display device for displaying said results of said collective choice.

5. A system as in claim 1 wherein said input device is a keyboard.

6. A system as in claim 1 wherein said input device is a pointing device.

7. A system as in claim 1 further comprising a library of input data objects which is accessible by said input data object generator.

8. A system as in claim 1 wherein said fields of said input data objects adapt to predetermined input data entered into said input data object by said input devices.

9. A system as in claim 1 wherein input data corresponding to a selection of one of a number of discrete choices is entered in said input data object.

10. A system as in claim 1 wherein input data corresponding to a selection of one of a number of indiscrete choices is entered in said input data object.

11. A system as in claim 1 wherein said choice generator uses a variety of predetermined scoring rules in generating said result of said collective choice.

12. A system as in claim 1 wherein said choice generator uses a combination of predetermined scoring rules to breaks ties which occur as a result of said collective choice.

13. A system as in claim 1 wherein said choice generator uses a variety of predetermined aggregation rules in generating said result of said collective choice.

14. A system as in claim 1 wherein said choice generator uses a weighting scheme in generating said result of said collective choice.

15. A method for making a collective choice, comprising the steps of:
(a) providing a communications network;
(b) providing one or more terminals coupled to said network; each of said one or more terminals having an input device;
(c) providing one or more servers coupled to said network;
(d) providing at least one database associated with said one or more servers; said at least one database having storage fields for receiving and providing data;
(e) generating a number of input data objects having input fields associated with related storage fields of said at least one database;
(f) delivering one of said number of input data objects to each of said one or more terminals so that each of said input devices can enter input data reflecting an individual choice into said input data object;
(g) sending said input data object to said at least one database for said input data to be received thereby;
(h) generating an output data object having output fields associated with one or more of said related storage fields of said at least one database; said at least one database to provide output data to said output data object; and
(i) receiving and manipulating said output data from said output data object to generate a result of a collective choice.

16. A method as in claim 15 further comprising the step of selecting at least one of said one or more terminals.

17. A method as in claim 16 further comprising the step of masking the identity of said one or more terminals from an administrator of said system.

18. A method as in claim 15 wherein each of said one or more terminals further includes a display device and wherein said method further comprises the step of displaying said results of said collective choice.

19. A method as in claim 15 wherein said input device is a keyboard.

20. A method as in claim 15 wherein said input device is a pointing device.

21. A method as in claim 15 further comprising the step of providing a library of input data objects which is accessible by said input data object generator.

22. A method as in claim 15 further comprising the step of dynamically adapting said fields of said input data objects in accordance with predetermined input data entered into said input data object by said input devices.

23. A method as in claim 15 further comprising the step of utilizing a variety of predetermined scoring rules in generating said result of said collective choice.

24. A method as in claim 15 further comprising the step of utilizing a combination of predetermined scoring rules to breaks ties which occur as a result of said collective choice.

25. A method as in claim 15 further comprising the step of entering a selection of one of a number of discrete choices in said input data object.

26. A method as in claim 15 further comprising the step of entering a selection of one of a number of indiscrete choices in said input data object.

27. A method as in claim 15 further comprising the step of utilizing a variety of predetermined aggregation rules in generating said result of said collective choice.

28. A method as in claim 15 further comprising the step of utilizing a weighting scheme in generating said result of said collective choice.

29. An article of manufacture comprising a machine usable medium having machine readable program code embodied therein for making a collective choice, said article of manufacture comprising:
(a) machine readable program code for controlling one or more terminals coupled to a communications network; each of said one or more terminals having an input device;
(b) machine readable program code for controlling one or more servers also coupled to said network;
(c) machine readable program code for maintaining at least one database associated with said one or more servers; said at least one database having storage fields for receiving input data and providing output data;
(d) machine readable program code for generating a number of input data objects having input fields associated with related storage fields of said at least one database;
(e) machine readable program code for delivering one of said number of input data objects to each of said one or more terminals so that each of said input devices can enter input data reflecting an individual choice into said input data object;
(f) machine readable program code for sending said input data object to said at least one database for said input data to be received thereby;
(g) machine readable program code for generating an output data object having output fields associated with one or more of said related storage fields of said at least one database; said at least one database to provide output data to said output data object; and
(h) machine readable program code for receiving and manipulating said ouput data from said output data object to generate a result of a collective choice.

30. An article of manufacture as in claim 29 further comprising machine readable program code for selecting at least one of said one or more terminals.

31. An article of manufacture as in claim 30 further comprising machine readable program code for masking the identity of said one or more terminals from an administrator of said system.

32. An article of manufacture as in claim 29 wherein each of said one or more terminals further includes a display device and wherein said article of manufacture further comprises machine readable program code for displaying said results of said collective choice on said display device.

33. An article of manufacture as in claim 29 wherein said input device is a keyboard.

34. An article of manufacture as in claim 29 wherein said input device is a pointing device.

35. An article of manufacture as in claim 29 further comprising machine readable program code for maintaining a library of input data objects.

36. An article of manufacture as in claim 29 further comprising machine readable program code for dynamically adapting said fields of said input data objects in accordance with predetermined input data entered into said input data object by said input devices.

37. An article of manufacture as in claim 29 further comprising machine readable program code for utilizing a variety of predetermined scoring rules in generating said result of said collective choice.

38. An article of manufacture as in claim 29 further comprising machine readable program code for utilizing a combination of predetermined scoring rules to breaks ties which occur as a result of said collective choice.

39. An article of manufacture as in claim 29 further comprising machine readable program code for entering a selection of one of a number of discrete choices in said input data object.

40. An article of manufacture as in claim 29 further comprising machine readable program code for entering a selection of one of a number of indiscrete choices in said input data object.

41. An article of manufacture as in claim 29 further comprising machine readable program code for utilizing a variety of predetermined aggregation rules in generating said result of said collective choice.

42. An article of manufacture as in claim 29 further comprising machine readable program code for utilizing a weighting scheme in generating said result of said collective choice.
